(19) United States
(12) Patent Application Publication
(10) Pub. No.: US 2025/0273388 A1
(43) Pub. Date: Aug. 28, 2025

(54) COIL COMPONENT

(71) Applicant: TDK Corporation, Tokyo (JP)

(72) Inventors: Toshinori MATSUURA, Tokyo (JP); Noriaki HAMACHI, Tokyo (JP); Shunya SUZUKI, Tokyo (JP); Kota OIKAWA, Tokyo (JP); Hajime KATO, Tokyo (JP)

(73) Assignee: TDK Corporation, Tokyo (JP)

(21) Appl. No.: 19/056,852

(22) Filed: Feb. 19, 2025

(30) Foreign Application Priority Data
Feb. 27, 2024 (JP) 2024-027740

(51) Int. Cl. H01F 27/29; H01F 27/02

(52) U.S. Cl. CPC H01F 27/292; H01F 27/027

(57) ABSTRACT

In a coil component, each of a plurality of coil conductors is connected at an end thereof to another coil conductor of the plurality of coil conductors. The plurality of coil conductors include a first coil conductor and a second coil conductor. The first coil conductor extends along a Y-axis direction. The second coil conductor is connected to the first coil conductor. The second coil conductor extends from the first coil conductor toward a second end surface such that the shortest distance from a side surface to the second coil conductor increases as the second coil conductor approaches the second end surface. When viewed along a second direction orthogonal to a direction of a coil axis of a coil and a first direction, the first coil conductor does not overlap a portion which is closest to the first coil conductor in the second side surface electrode portion.

### TECHNICAL FIELD The present invention relates to a coil component.

### BACKGROUND

A known coil component includes an element body, an external electrode provided on the element body, and a coil disposed inside the element body (for example, JP2018-56513). The coil is connected to the external electrode. The coil includes a plurality of coil conductors.

### SUMMARY

In the above-described coil component, in order to secure inductance, it is conceivable to increase the area of a region surrounded by the coil when viewed along a coil axis direction. In the coil components having the same size, as the area of the region is larger, the shortest distance between the coil and the external electrode is smaller. The inventor of the present application has focused on a phenomenon in which a Q value decreases when an electric signal in a relatively high frequency band conducts through a coil even if a desired Q value is secured when an electric signal in a relatively low frequency band conducts through the coil.

An object of one aspect of the present invention is to provide a coil component capable of securing both inductance and a Q value for an electric signal in a relatively high frequency band while achieving compactness.

As a result of further intensive studies, the inventor of the present application has found that when there is a position where a potential difference between the coil and the external electrode is relatively large and the distance is relatively short, the Q value decreases for an electric signal having a relatively low frequency. A coil component according to one aspect of the present invention includes an element body, a first external electrode, a second external electrode, and a coil. The element body includes first and second end surfaces opposite to each other in a first direction, and a side surface connecting the first and second end surfaces. The first external electrode includes a first end surface electrode portion provided on the first end surface, and a first side surface electrode portion provided on the side surface and extending from the first end surface toward the second end surface. The second external electrode includes a second end surface electrode portion provided on the second end surface, and a second side surface electrode portion provided on the side surface and extending from the second end surface toward the first end surface. The coil is disposed inside the element body. The coil is connected to the first end surface electrode portion at the first end surface, and is connected to the second end surface electrode portion at the second end surface. The coil includes a plurality of coil conductors. Each of the plurality of coil conductors includes a pair of ends, and is connected at the end to another coil conductor of the plurality of coil conductors. The plurality of coil conductors include a first coil conductor and a second coil conductor. The first coil conductor extends along the first direction. The second coil conductor is connected to the first coil conductor. The second coil conductor extends from the first coil conductor toward the second end surface such that the shortest distance from the side surface to the second coil conductor increases as the second coil conductor approaches the second end surface. When viewed along a second direction orthogonal to a coil axis direction of the coil and the first direction, the first coil conductor does not overlap a portion which is closest to the first coil conductor in the second side surface electrode portion.

In this coil component, since the first coil conductor connected to the first external electrode is separated from the second external electrode as viewed along the second direction, the Q value can be secured even for a signal in a relatively high frequency band while achieving compactness. Since the second coil conductor is connected to the first coil conductor, and extends from the first coil conductor toward the second end surface such that the shortest distance from the side surface to the second coil conductor increases as the second coil conductor approaches the second end surface, the area of a region surrounded by the coil can be secured when viewed along the coil axis direction. As a result, it is possible to secure inductance while achieving compactness.

In the one aspect, the coil may further include a third coil conductor connected to the end different from the end connected to the first coil conductor, in the pair of ends of the second coil conductor. The third coil conductor may extend along the second direction. In this case, when viewed along the coil axis direction, a larger area of the region surrounded by the coil can be secured. As a result, it is possible to more reliably secure inductance while achieving compactness.

In the one aspect, a portion of the coil may overlap the second side surface electrode portion when viewed along the second direction. In this case, when viewed along the coil axis direction, a larger area of the region surrounded by the coil can be secured. As a result, it is possible to more reliably secure inductance while achieving compactness.

In the one aspect, the region surrounded by the plurality of coil conductors may have an octagonal shape when viewed along the coil axis direction. In this case, when viewed along the coil axis direction, a larger area of the region surrounded by the coil can be secured. As a result, it is possible to more reliably secure inductance while achieving compactness.

### Advantageous Effects of Invention

One aspect of the present invention provides a coil component capable of securing both inductance and a Q value for an electric signal in a relatively high frequency band while achieving compactness.

### BRIEF DESCRIPTION OF THE DRAWINGS

FIG. 1 is a perspective view of a coil component in an embodiment;

FIG. 2 is a partial cross-sectional view of the coil component in a YZ-axis plane;

FIG. 3 is a partial cross-sectional view of the coil component in an XY-axis plane;

FIG. 4 is a partial cross-sectional view of the coil component in an XZ-axis plane;

FIG. 5 is a partial cross-sectional view of a coil component in the YZ-axis plane in a modification of the embodiment;

FIG. 6 is a partial cross-sectional view of the coil component in the XY-axis plane;

FIG. 7 is a partial cross-sectional view of the coil component in the XZ-axis plane;

FIGS. 8A to 8D illustrate a coil conductor in each layer; and

FIG. 9 is a graph illustrating frequency characteristics of a Q value.

### DETAILED DESCRIPTION

Hereinafter, embodiments of the present invention will be described in detail with reference to the accompanying drawings. In the description of the drawings, the same reference numerals are used for the same or equivalent elements, and redundant description will be omitted.

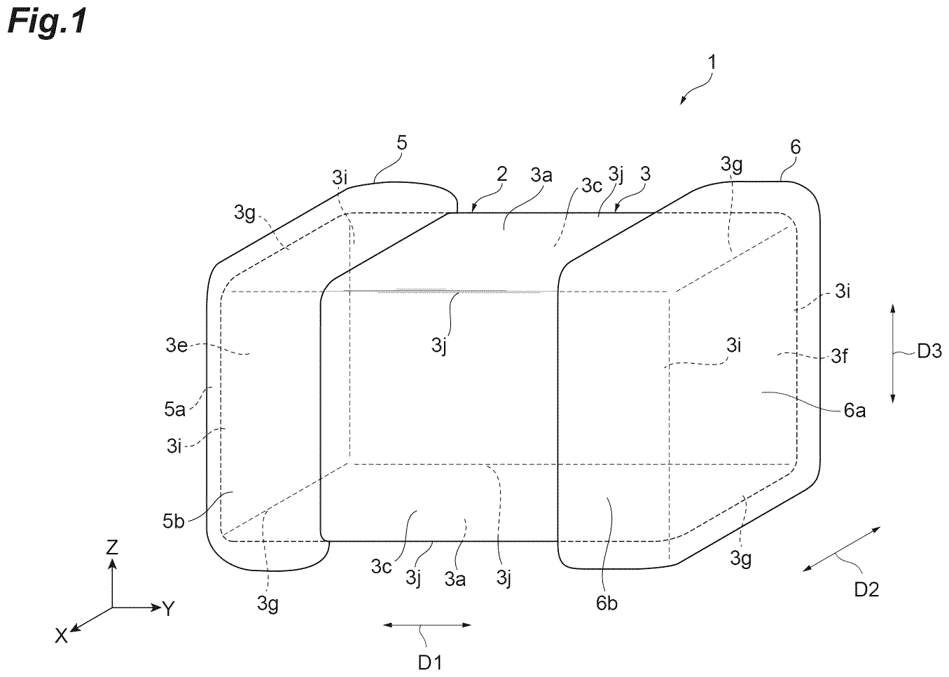

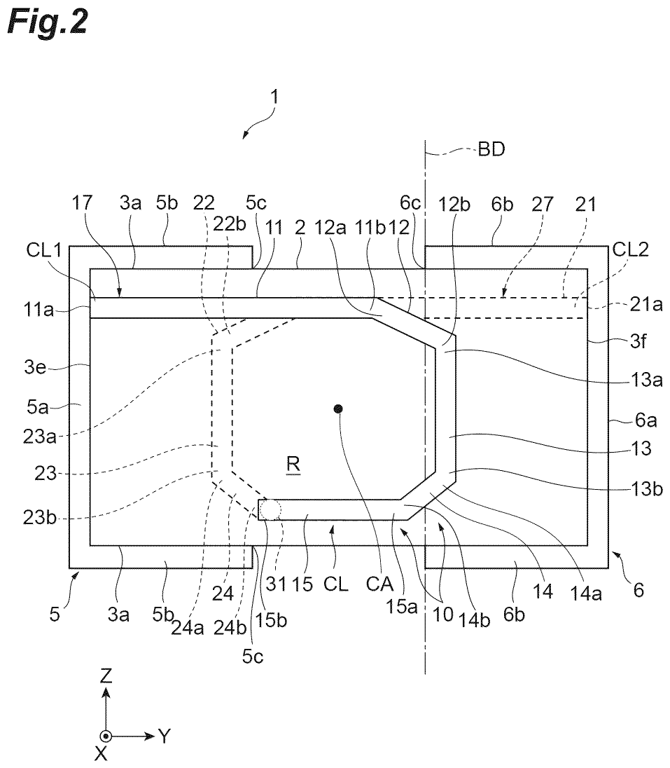

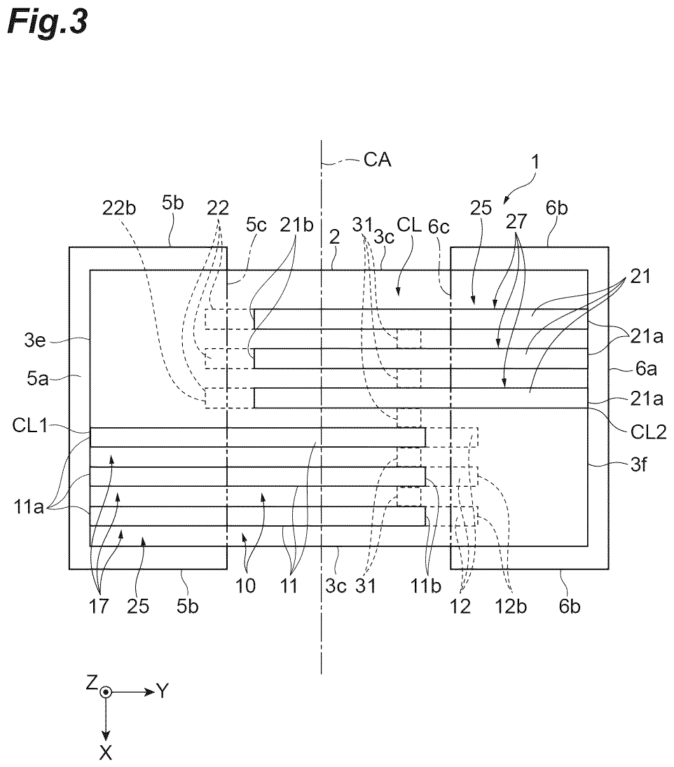

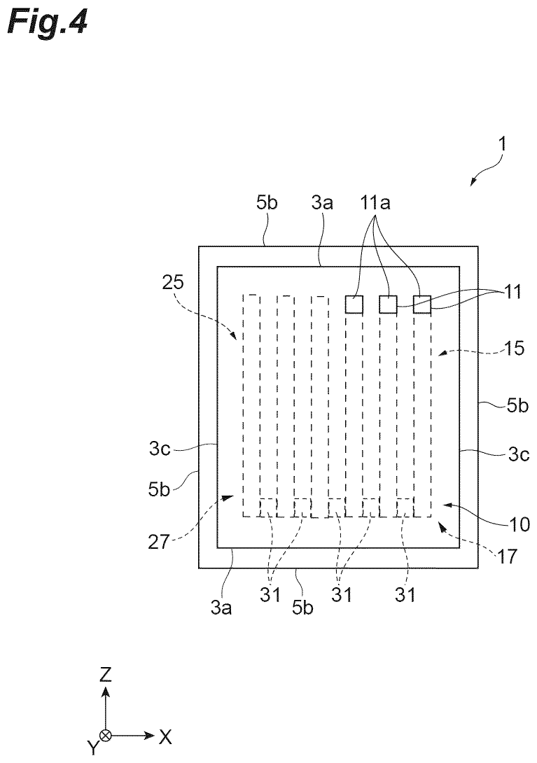

First, a coil component in the present embodiment will be described with reference to FIGS. 1 to 4. The coil component 1 is, for example, a multilayer coil component. FIG. 1 is a perspective view of the coil component in the present embodiment. FIG. 2 is a partial cross-sectional view of the coil component in a YZ-axis plane. FIG. 3 is a partial cross-sectional view of the coil component in an XY-axis plane. FIG. 4 is a partial cross-sectional view of the coil component in an XZ-axis plane.

As illustrated in FIG. 1, the coil component 1 includes an element body 2 and external electrodes 5 and 6. For example, when the external electrode 5 is a first external electrode, the external electrode 6 corresponds to a second external electrode. The coil component 1 is solder-mounted to an electronic device, for example. The electronic device includes, for example, a circuit board or an electronic component. In the present embodiment, the element body 2 is formed by a plurality of element body layers stacked in an X-axis direction.

The element body 2 has, for example, an insulating property. The element body 2 is made of, for example, a magnetic material. The magnetic material includes, for example, at least one selected from a Ni—Cu—Zn ferrite material, a Ni—Cu—Zn—Mg ferrite material, and a Ni—Cu ferrite material. The magnetic material constituting the element body 2 may contain an Fe alloy or the like. The element body 2 may be made of a nonmagnetic material. The nonmagnetic material includes, for example, at least one selected from a glass ceramic material and a dielectric material.

The element body 2 has, for example, a rectangular parallelepiped shape. The rectangular parallelepiped shape includes a rectangular parallelepiped shape in which corner portions and ridge portions are chamfered, and a rectangular parallelepiped shape in which the corner portions and the ridge portions are rounded. The rectangular parallelepiped shape includes a shape having a depression.

The element body 2 has a pair of side surfaces 3a opposite to each other, a pair of side surfaces 3c opposite to each other, and a pair of end surfaces 3e and 3f opposite to each other. Each of the side surfaces 3a and 3c is connected to the pair of end surfaces 3e and 3f. The pair of side surfaces 3a, the pair of side surfaces 3c, and the pair of end surfaces 3e and 3f have a rectangular shape. A direction in which the pair of side surfaces 3a is opposite to each other is a third direction D3. A direction in which the pair of side surfaces 3c is opposite to each other is a second direction D2. A direction in which the pair of end surfaces 3e and 3f is opposite to each other is a first direction D1. The first direction D1 and the second direction D2 intersect with each other. The third direction D3 intersects the first direction D1 and the second direction D2. In the example illustrated in the present embodiment, the first direction D1, the second direction D2, and the third direction D3 are orthogonal to each other.

The coil component 1 is solder-mounted to an electronic device. The electronic device includes, for example, a circuit board or a multilayer coil component. In the coil component 1, one side surface 3a faces the electronic device. The one side surface 3a is disposed so as to constitute a mounting surface. The one side surface 3a is the mounting surface. One side surface 3c of the pair of side surfaces 3c may be disposed to constitute the mounting surface. For example, when the side surface 3a constitutes a first side surface, the side surface 3c constitutes a second side surface.

For example, the third direction D3 is orthogonal to each of the side surfaces 3a. The first direction D1 is parallel to each of the side surfaces 3a and each of the side surfaces 3c. The second direction D2 is orthogonal to each of the side surfaces 3c. In the present embodiment, the length of the element body 2 in the first direction D1 is larger than the length of the element body 2 in the second direction D2, and is larger than the length of the element body 2 in the third direction D3. The first direction D1 is a longitudinal direction of the element body 2. The length of the element body 2 in the second direction D2 and the length of the element body 2 in the third direction D3 may be equal to each other. The length of the element body 2 in the first direction D1 and the length of the element body 2 in the third direction D3 may be different from each other. In the example illustrated in the present embodiment, the first direction D1 corresponds to a Y-axis direction, the second direction D2 corresponds to the X-axis direction, and the third direction D3 corresponds to a Z-axis direction.

The length of the element body 2 in the third direction D3 is the height of the element body 2. The length of the element body 2 in the second direction D2 is the width of the element body 2. The length of the element body 2 in the first direction D1 is the length of the element body 2. In the present embodiment, a height T of the element body 2 is 0.05 to 1 mm, a width W of the element body 2 is 0.05 to 1 mm, and a length L of the element body 2 is 0.1 to 2 mm. For example, the height T of the element body 2 is 0.3 mm, the width W of the element body 2 is 0.2 mm, and the length L of the element body 2 is 0.4 mm.

The pair of side surfaces 3c extends in the third direction D3 so as to couple the pair of side surfaces 3a to each other. The pair of side surfaces 3c also extends in the first direction D1. The pair of end surfaces 3e and 3f extends in the third direction D3 so as to couple the pair of side surfaces 3a to each other. The pair of end surfaces 3e and 3f also extends in the second direction D2.

The element body 2 includes four ridge portions 3g, four ridge portions 3i, and four ridge portions 3j. The ridge portions 3g are located between the end surfaces 3e and 3f and the side surface 3a. The ridge portions 3i are located between the end surfaces 3e and 3f and the side surface 3c. The ridge portion 3j is located between the side surface 3a and the side surface 3c. In the present embodiment, each of the ridge portions 3g, 3i, and 3j is rounded so as to be curved. The element body 2 is subjected to so-called round chamfering. The end surfaces 3e and 3f and the side surface 3a are indirectly adjacent to each other via the ridge portions 3g. The end surfaces 3e and 3f and the side surface 3c are indirectly adjacent to each other via the ridge portions 3i. The side surface 3a and the side surface 3c are indirectly adjacent to each other via the ridge portion 3j.

The pair of external electrodes 5 and 6 is disposed on an outer surface of the element body 2 while being separated from each other. The pair of external electrodes 5 and 6 is opposite to each other in the Z-axis direction. The pair of external electrodes 5 and 6 is separated from each other in the Z-axis direction. The external electrodes 5 and 6 are each provided on the pair of side surfaces 3c and the pair of side surfaces 3a.

The pair of external electrodes 5 and 6 is formed by a known method. The pair of external electrodes 5 and 6 is made of, for example, a metal material. The metal material is, for example, copper, silver, gold, nickel, or chromium. The pair of external electrodes 5 and 6 is formed, for example, by subjecting an electrode layer to plating treatment. The electrode layer is made of, for example, a conductive paste. The conductive paste is applied by, for example, a dipping method, a printing method, or a transfer method. The electrode layer may be formed by, for example, a photolithography method. The plating treatment is, for example, electrolytic plating or electroless plating. By this plating treatment, a plating layer is formed on an outer surface of the conductive paste.

The external electrode 5 includes, for example, an end surface electrode portion 5a and a side surface electrode portion 5b. The end surface electrode portion 5a is provided on the end surface 3e. The side surface electrode portion 5b is provided on the pair of side surfaces 3a and the pair of side surfaces 3c. The side surface electrode portion 5b extends from the end surface 3e toward the end surface 3f. The external electrode 6 includes, for example, an end surface electrode portion 6a and a side surface electrode portion 6b. The end surface electrode portion 6a is provided on the end surface 3f. The side surface electrode portion 6b is provided on the pair of side surfaces 3a and the pair of side surfaces 3c. The side surface electrode portion 6b extends from the end surface 3f toward the end surface 3e. The side surface electrode portion 5b and the side surface electrode portion 6b cover, for example, a portion of each of the side surfaces 3a and a portion of each of the side surfaces 3c.

In the example illustrated in the present embodiment, the side surface electrode portion 5b of the external electrode 5 and the side surface electrode portion 6b of the external electrode 6 are formed in an annular shape. In each of the side surfaces 3a and 3c, a region covered with the side surface electrode portion 5b and the side surface electrode portion 6b has, for example, a rectangular shape when viewed from the X-axis direction or the Z-axis direction. In the present specification, the term “couple” means connecting in a directly contacted state. The phrase “directly contact” means that members are connected to each other without interposing another member illustrated in the present specification. The phrase “directly contact” does not exclude being connected via a member not explicitly described herein. The term “connect” includes not only a directly contacted state but also a physically separated and electrically connected state unless otherwise specified.

As illustrated in FIGS. 2 to 4, the coil component 1 further includes a coil CL. The coil CL is disposed inside the element body 2. FIG. 2 is a partial cross-sectional view of the coil component in the YZ-axis plane. FIG. 3 is a partial cross-sectional view of the coil component in the XY-axis plane. FIG. 4 is a partial cross-sectional view of the coil component in the XZ-axis plane.

The coil CL electrically connects the external electrode 5 and the external electrode 6. The coil CL forms a coil axis CA along an opposite direction of the pair of side surfaces 3c. The coil axis CA extends, for example, in the X-axis direction. That is, the X-axis direction corresponds to a coil axis direction. The coil CL includes ends CL1 and CL2 separated from each other. For example, the coil CL has a spiral structure in which the coil advances clockwise from the end CL1 toward the end CL2 when viewed from the X-axis direction.

The end CL1 of the coil CL is connected to the external electrode 5. The end CL2 of the coil CL is connected to the external electrode 6. A portion of the coil CL overlaps the side surface electrode portions 5b and 6b when viewed along the Z-axis direction. The coil CL includes a plurality of coil conductors 10. The plurality of coil conductors 10 correspond to internal conductors. The plurality of coil conductors 10 include a plurality of coil conductors 11, 12, 13, 14, 15, 21, 22, 23, and 24. In the example illustrated in the present embodiment, the coil CL is a triple-wound coil and includes three each of the coil conductors 11, 12, 13, 14, 15, 21, 22, 23, and 24. Each of the plurality of coil conductors 10 is coupled at an end thereof to another coil conductor 10 of the plurality of coil conductors 10. In the example illustrated in the present embodiment, a region R surrounded by the plurality of coil conductors 10 has an octagonal shape when viewed along a direction of the coil axis CA, that is, along the X-axis direction.

The plurality of coil conductors 11, 12, 13, 14, 15, 21, 22, 23, and 24 are electrically connected to each other. In the example illustrated in the present embodiment, the plurality of coil conductors 11, 12, 13, 14, and 15 are provided in the same layer. The plurality of coil conductors 11, 12, 13, 14, and 15 form a coil conductor layer 17. The plurality of coil conductors 21, 22, 23, and 24 are provided in the same layer. The plurality of coil conductors 21, 22, 23, and 24 form a coil conductor layer 27. A plurality of the coil conductor layers 17 and a plurality of the coil conductor layers 27 are provided at different positions in the X-axis direction.

The coil conductor 11 includes a pair of ends 11a and 11b. The coil conductor 12 includes a pair of ends 12a and 12b. The coil conductor 13 includes a pair of ends 13a and 13b. The coil conductor 14 includes a pair of ends 14a and 14b. The coil conductor 15 includes a pair of ends 15a and 15b.

The end 11a of the coil conductor 11 is exposed from the end surface 3e of the element body 2, and is coupled to the end surface electrode portion 5a of the external electrode 5 at the end surface 3e. The end 11b of the coil conductor 11 and the end 12a of the coil conductor 12 are coupled to each other. The end 12b of the coil conductor 12 and the end 13a of the coil conductor 13 are coupled to each other. The end 13b of the coil conductor 13 and the end 14a of the coil conductor 14 are coupled to each other. The end 14b of the coil conductor 14 and the end 15a of the coil conductor 15 are coupled to each other.

The coil conductor 11 extends along the Y-axis direction. When viewed along the Z-axis direction orthogonal to the direction of the coil axis CA of the coil CL and the Y-axis direction, the coil conductor 11 does not overlap a portion 6c which is closest to the coil conductor 11 in the side surface electrode portion 6b. The portion 6c corresponds to an edge of the side surface electrode portion 6b opposite to the side surface electrode portion 5b in the Y axis direction, and the coil conductor 11 does not overlap a boundary BD formed by the edge. The coil conductor 11 is separated from the portion 6c which is closest to the coil conductor 11 in the side surface electrode portion 6b in the Y-axis direction. In the example illustrated in the present embodiment, when viewed along the Z-axis direction, the coil conductor 11 does not overlap the side surface electrode portion 6b provided on the side surface 3a close to the coil conductor 11 in the pair of side surfaces 3a. In the example illustrated in the present embodiment, when viewed along the Z-axis direction, the coil conductor 11 does not overlap the side surface electrode portion 6b provided on each of the pair of side surfaces 3a. The coil conductor 11 is separated from the side surface electrode portion 6b provided on each of the pair of side surfaces 3a in the Y-axis direction.

The coil conductor 12 extends from the coil conductor 11 toward the end surface 3f such that the shortest distance from the side surface 3a to the coil conductor 12 increases as the coil conductor 12 approaches the end surface 3f. In other words, the coil conductor 12 extends from the coil conductor 13 toward the end surface 3e such that the shortest distance from the side surface 3a to the coil conductor 12 decreases as the distance from the end surface 3f increases. A portion of the coil conductor 12 overlaps the side surface electrode portion 6b when viewed along the Z-axis direction. The boundary BD passes through the coil conductor 12. The coil conductor 12 is orthogonal to the X-axis direction and extends in a direction inclined with respect to the Y-axis direction and the Z-axis direction.

The coil conductor 13 is connected to the end 12b different from the end 12a connected to the coil conductor 11, in the pair of ends 12a and 12b of the coil conductor 12. The coil conductor 13 extends in the Z-axis direction. A longitudinal direction of the coil conductor 13 is orthogonal to the pair of side surfaces 3a. The entire coil conductor 13 overlaps the side surface electrode portion 6b when viewed along the Z-axis direction.

The coil conductor 14 extends from the coil conductor 15 toward the end surface 3f such that the shortest distance from the side surface 3a to the coil conductor 14 increases as the coil conductor 14 approaches the end surface 3f. In other words, the coil conductor 14 extends from the coil conductor 13 toward the end surface 3e such that the shortest distance from the side surface 3a to the coil conductor 14 decreases as the distance from the end surface 3f increases. A portion of the coil conductor 14 overlaps the side surface electrode portion 6b when viewed along the Z-axis direction. The coil conductor 14 is orthogonal to the X-axis direction and extends in a direction inclined with respect to the Y-axis direction and the Z-axis direction.

The coil conductor 15 extends along the Y-axis direction. When viewed along the Z-axis direction orthogonal to the direction of the coil axis CA of the coil CL and the Y-axis direction, the coil conductor 15 does not overlap a portion 5c which is closest to the coil conductor 15 in the side surface electrode portion 5b. When viewed along the Z-axis direction, the coil conductor 15 does not overlap the portion 6c which is closest to the coil conductor 15 in the side surface electrode portion 6b. The coil conductor 15 is separated from the portion 5c which is closest to the coil conductor 15 in the side surface electrode portion 5b in the Y-axis direction. The coil conductor 15 is separated from the portion 6c which is closest to the coil conductor 15 in the side surface electrode portion 6c in the Y-axis direction. The coil conductor 15 is connected to the end 14b different from the end 14a connected to the coil conductor 13, in the pair of ends 14a and 14b of the coil conductor 14.

In the example illustrated in the present embodiment, when viewed along the Z-axis direction, the coil conductor 15 does not overlap the side surface electrode portion 5b provided on the side surface 3a close to the coil conductor 15 in the pair of side surfaces 3a. When viewed along the Z-axis direction, the coil conductor 15 does not overlap the side surface electrode portion 6b provided on the side surface 3a close to the coil conductor 15 in the pair of side surfaces 3a. In the example illustrated in the present embodiment, when viewed along the Z-axis direction, the coil conductor 15 does not overlap the side surface electrode portion 5b provided on each of the pair of side surfaces 3a. When viewed along the Z-axis direction, the coil conductor 15 does not overlap the side surface electrode portion 6b provided on each of the pair of side surfaces 3a. The coil conductor 15 is separated from the side surface electrode portions 5b and 6b provided on each of the pair of side surfaces 3a in the Y-axis direction.

The coil conductor 21 includes a pair of ends 21a and 21b. The plurality of coil conductors 22 include a pair of ends 22a and 22b. The plurality of coil conductors 23 include a pair of ends 23a and 23b. The plurality of coil conductors 24 include a pair of ends 24a and 24b.

The end 21a of the coil conductor 21 is exposed from the end surface 3f opposite to the end surface 3e from which the end 11a is exposed, in the pair of end surfaces 3e and 3f, and is coupled to the end surface electrode portion 6a of the external electrode 6 at the end surface 3f. The end 21b of the coil conductor 21 and the end 22a of the coil conductor 22 are coupled to each other. The end 22b of the coil conductor 22 and the end 23a of the coil conductor 23 are coupled to each other. The end 23b of the coil conductor 23 and the end 24a of the coil conductor 24 are coupled to each other. The end 24b of the coil conductor 24 and the end 15b of the coil conductor 15 are connected to each other via a via 31.

The coil conductor 21 extends along the Y-axis direction. When viewed along the Z-axis direction orthogonal to the direction of the coil axis CA of the coil CL and the Y-axis direction, the coil conductor 21 does not overlap the portion 5c which is closest to the coil conductor 21 in the side surface electrode portion 5b. The coil conductor 21 is separated from the portion 5c which is closest to the coil conductor 21 in the side surface electrode portion 5b in the Y-axis direction. In the example illustrated in the present embodiment, when viewed along the Z-axis direction, the coil conductor 21 does not overlap the side surface electrode portion 5b provided on the side surface 3a close to the coil conductor 21 in the pair of side surfaces 3a. In the example illustrated in the present embodiment, when viewed along the Z-axis direction, the coil conductor 21 does not overlap the side surface electrode portion 5b provided on each of the pair of side surfaces 3a. The coil conductor 21 is separated from the side surface electrode portion 5b provided on each of the pair of side surfaces 3a in the Y-axis direction.

The coil conductor 22 extends from the coil conductor 21 toward the end surface 3e such that the shortest distance from the side surface 3a to the coil conductor 22 increases as the coil conductor 22 approaches the end surface 3e. In other words, the coil conductor 22 extends from the coil conductor 23 toward the end surface 3f such that the shortest distance from the side surface 3a to the coil conductor 22 decreases as the distance from the end surface 3e increases. A portion of the coil conductor 22 overlaps the side surface electrode portion 5b when viewed along the Z-axis direction. The coil conductor 22 is orthogonal to the X-axis direction and extends in a direction inclined with respect to the Y-axis direction and the Z-axis direction.

The coil conductor 23 is connected to the end 22b of the pair of ends 22a and 22b of the coil conductor 22. The coil conductor 23 extends in the Z-axis direction. A longitudinal direction of the coil conductor 23 is orthogonal to the pair of side surfaces 3a. The entire coil conductor 23 overlaps the side surface electrode portion 5b when viewed along the Z-axis direction.

The coil conductor 24 extends from the coil conductor 15 toward the end surface 3e such that the shortest distance from the side surface 3a to the coil conductor 24 increases as the coil conductor 24 approaches the end surface 3e. In other words, the coil conductor 24 extends from the coil conductor 23 toward the end surface 3f such that the shortest distance from the side surface 3a to the coil conductor 24 decreases as the distance from the end surface 3e increases. A portion of the coil conductor 24 overlaps the side surface electrode portion 5b when viewed along the Z-axis direction. The coil conductor 24 is orthogonal to the X-axis direction and extends in a direction inclined with respect to the Y-axis direction and the Z-axis direction.

The coil CL is made of a conductive material. An internal conductor layer provided inside the coil component 1 is made of a conductive material. The conductive material contains, for example, at least one selected from Ag and Pd.

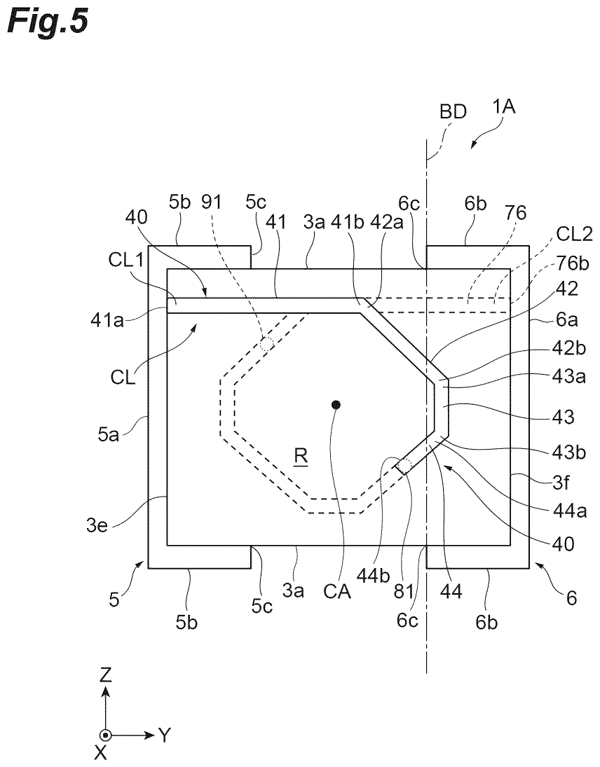

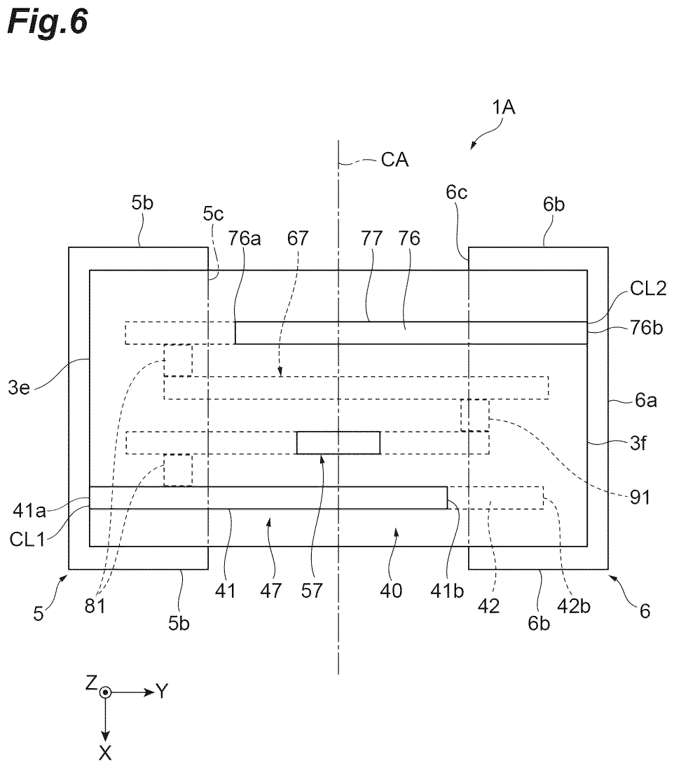

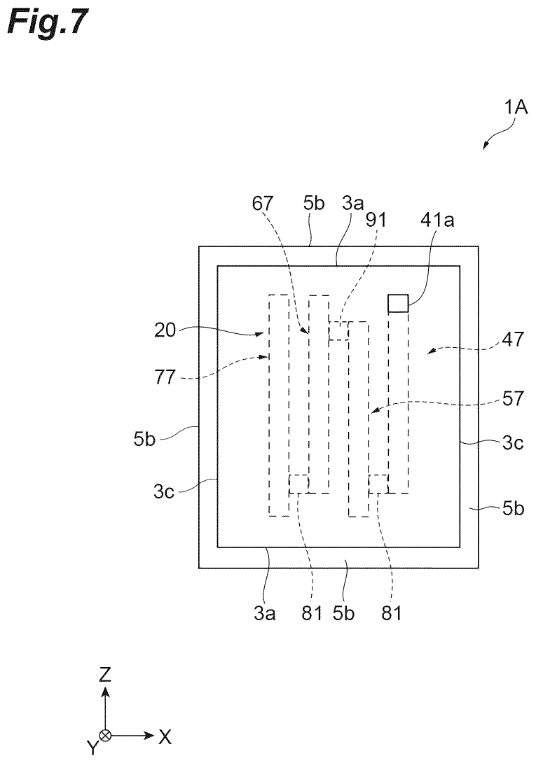

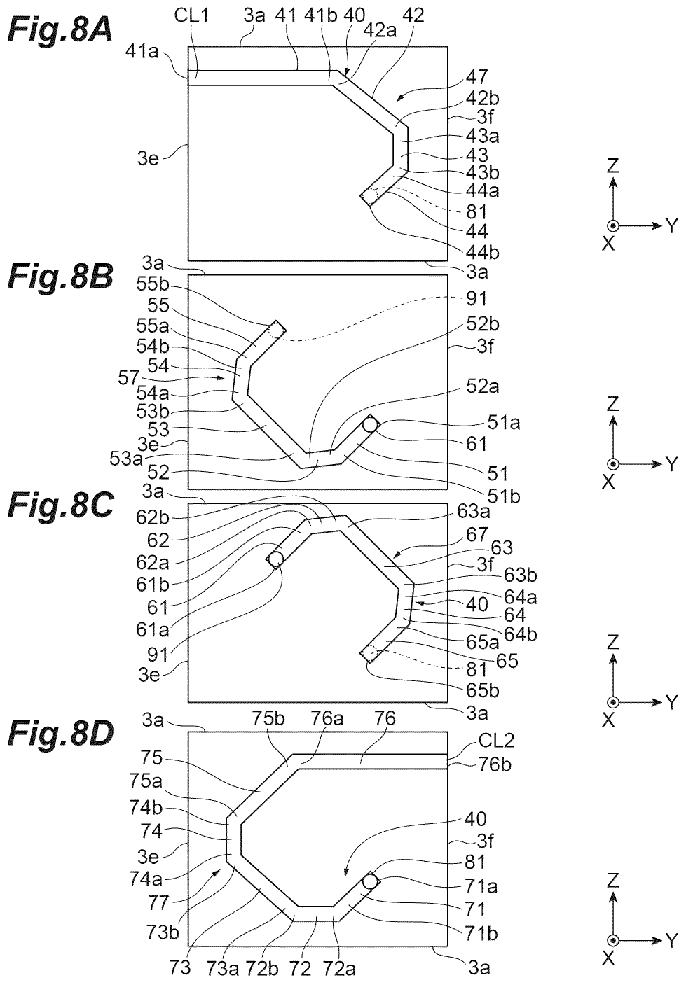

Next, a coil component 1A in a modification of the present embodiment will be described with reference to FIGS. 5 to 8D. FIG. 5 is a partial cross-sectional view of the coil component in the YZ-axis plane in the modification of the present embodiment. FIG. 6 is a partial cross-sectional view of the coil component in the XY-axis plane. FIG. 7 is a partial cross-sectional view of the coil component in the XZ-axis plane. FIGS. 8A to 8D illustrate a coil conductor in each layer. The present modification is generally similar to or the same as the coil component 1 in the above-described embodiment. The present modification is different from the above-described embodiment in that the configuration of the coil CL is different. Hereinafter, differences between the above-described embodiment and the modification will be mainly described.

The coil CL includes a plurality of coil conductors 40. The plurality of coil conductors 40 correspond to internal conductors. The plurality of coil conductors 40 include a plurality of coil conductors 41, 42, 43, 44, 51, 52, 53, 54, and 55 and a plurality of coil conductors 61, 62, 63, 64, 65, 71, 72, 73, 74, 75, and 76. In the present modification, the coil CL is a single-wound coil. The plurality of coil conductors 41, 42, 43, 44, 51, 52, 53, 54, and 55 and the plurality of coil conductors 61, 62, 63, 64, 65 71, 72, 73, 74, 75, and 76 are electrically connected to each other.

In the present modification, the plurality of coil conductors 41, 42, 43, and 44 are provided in the same layer. The plurality of coil conductors 41, 42,43, and 44 form a coil conductor layer 47. The plurality of coil conductors 51, 52, 53, 54, and 55 are provided in the same layer. The plurality of coil conductors 51, 52, 53, 54, and 55 form a coil conductor layer 57. The plurality of coil conductors 61, 62, 63, 64, and 65 are provided in the same layer. The plurality of coil conductors 61, 62, 63, 64, and 65 form a coil conductor layer 67. The plurality of coil conductors 71, 72, 73, 74, 75, and 76 are provided in the same layer. The plurality of coil conductors 71, 72, 73, 74, 75, and 76 form a coil conductor layer 77. The coil conductor layer 47, the coil conductor layer 57, the coil conductor layer 67, and the coil conductor layer 77 are provided at different positions in the X-axis direction.

The coil conductor 41 includes a pair of ends 41a and 41b. The coil conductor 42 includes a pair of ends 42a and 42b. The coil conductor 43 includes a pair of ends 43a and 43b. The coil conductor 44 includes a pair of ends 44a and 44b.

The end 41a of the coil conductor 41 is exposed from the end surface 3e of the element body 2, and is coupled to the end surface electrode portion 5a of the external electrode 5 at the end surface 3e. The end 41b of the coil conductor 41 and the end 42a of the coil conductor 42 are coupled to each other. The end 42b of the coil conductor 42 and the end 43a of the coil conductor 43 are coupled to each other. The end 43b of the coil conductor 43 and the end 44a of the coil conductor 44 are coupled to each other.

The coil conductor 41 extends along the Y-axis direction. When viewed along the Z-axis direction orthogonal to the direction of the coil axis CA of the coil CL and the Y-axis direction, the coil conductor 41 does not overlap the portion 6c which is closest to the coil conductor 41 in the side surface electrode portion 6b. The coil conductor 41 is separated from the portion 6c which is closest to the coil conductor 41 in the side surface electrode portion 6b in the Y-axis direction. In the example illustrated in the present embodiment, when viewed along the Z-axis direction, the coil conductor 41 does not overlap the side surface electrode portion 6b provided on the side surface 3a close to the coil conductor 41 in the pair of side surfaces 3a. In the example illustrated in the present embodiment, when viewed along the Z-axis direction, the coil conductor 41 does not overlap the side surface electrode portion 6b provided on each of the pair of side surfaces 3a. The coil conductor 41 is separated from the side surface electrode portion 6b provided on each of the pair of side surfaces 3a in the Y-axis direction.

The coil conductor 42 extends from the coil conductor 41 toward the end surface 3f such that the shortest distance from the side surface 3a to the coil conductor 42 increases as the coil conductor 42 approaches the end surface 3f. In other words, the coil conductor 42 extends from the coil conductor 43 toward the end surface 3e such that the shortest distance from the side surface 3a to the coil conductor 42 decreases as the distance from the end surface 3f increases. A portion of the coil conductor 42 overlaps the side surface electrode portion 6b when viewed along the Z-axis direction. The coil conductor 42 is orthogonal to the X-axis direction and extends in a direction inclined with respect to the Y-axis direction and the Z-axis direction.

The coil conductor 43 is connected to the end 42b different from the end 42a connected to the coil conductor 44, in the pair of ends 42a and 42b of the coil conductor 42. The coil conductor 43 extends in the Z-axis direction. A longitudinal direction of the coil conductor 43 is orthogonal to the pair of side surfaces 3a. The entire coil conductor 43 overlaps the side surface electrode portion 6b when viewed along the Z-axis direction.

The coil conductor 44 extends from the coil conductor 51 toward the end surface 3f such that the shortest distance from the side surface 3a to the coil conductor 44 increases as the coil conductor 44 approaches the end surface 3f. In other words, the coil conductor 44 extends from the coil conductor 43 toward the end surface 3e such that the shortest distance from the side surface 3a to the coil conductor 44 decreases as the distance from the end surface 3f increases. A portion of the coil conductor 44 overlaps the side surface electrode portion 6b when viewed along the Z-axis direction. The coil conductor 44 is orthogonal to the X-axis direction and extends in a direction inclined with respect to the Y-axis direction and the Z-axis direction.

The coil conductor 51 includes a pair of ends 51a and 51b. The coil conductor 52 includes a pair of ends 52a and 52b. The coil conductor 53 includes a pair of ends 53a and 53b. The coil conductor 54 includes a pair of ends 54a and 54b. The coil conductor 55 includes a pair of ends 55a and 55b.

The end 51b of the coil conductor 51 and the end 52a of the coil conductor 52 are coupled to each other. The end 52b of the coil conductor 52 and the end 53a of the coil conductor 53 are coupled to each other. The end 53b of the coil conductor 53 and the end 54a of the coil conductor 54 are coupled to each other. The end 54b of the coil conductor 54 and the end 55a of the coil conductor 55 are coupled to each other.

The coil conductor 51 extends in the same direction as the coil conductor 44. When viewed along the X-axis direction, the coil conductor 51 and the coil conductor 44 are located on the same straight line. The end 44b of the coil conductor 44 and the end 51a of the coil conductor 51 are connected to each other via a via 81.

The coil conductor 52 extends along the Y-axis direction. When viewed along the Z-axis direction orthogonal to the direction of the coil axis CA of the coil CL and the Y-axis direction, the coil conductor 52 does not overlap the portion 5c which is closest to the coil conductor 52 in the side surface electrode portion 5b. When viewed along the Z-axis direction, the coil conductor 52 does not overlap the portion 6c which is closest to the coil conductor 52 in the side surface electrode portion 6b. The coil conductor 52 is separated from the portion 5c which is closest to the coil conductor 52 in the side surface electrode portion 5b in the Y-axis direction. The coil conductor 52 is separated from the portion 6c which is closest to the coil conductor 52 in the side surface electrode portion 6b in the Y-axis direction. The coil conductor 52 is connected to the end 51b of the coil conductor 51.

In the present modification, when viewed along the Z-axis direction, the coil conductor 52 does not overlap the side surface electrode portion 5b provided on the side surface 3a close to the coil conductor 52 in the pair of side surfaces 3a. When viewed along the Z-axis direction, the coil conductor 52 does not overlap the side surface electrode portion 6b provided on the side surface 3a close to the coil conductor 52 in the pair of side surfaces 3a. In the present modification, when viewed along the Z-axis direction, the coil conductor 52 does not overlap the side surface electrode portion 5b provided on each of the pair of side surfaces 3a. When viewed along the Z-axis direction, the coil conductor 52 does not overlap the side surface electrode portion 6b provided on each of the pair of side surfaces 3a. The coil conductor 52 is separated from the side surface electrode portions 5b and 6b provided on each of the pair of side surfaces 3a in the Y-axis direction.

The coil conductor 53 extends from the coil conductor 52 toward the end surface 3e such that the shortest distance from the side surface 3a to the coil conductor 53 increases as the coil conductor 53 approaches the end surface 3e. In other words, the coil conductor 53 extends from the coil conductor 54 toward the end surface 3f such that the shortest distance from the side surface 3a to the coil conductor 53 decreases as the distance from the end surface 3e increases. A portion of the coil conductor 53 overlaps the side surface electrode portion 5b when viewed along the Z-axis direction. The coil conductor 53 is orthogonal to the X-axis direction and extends in a direction inclined with respect to the Y-axis direction and the Z-axis direction.

The coil conductor 54 is connected to the end 53b of the pair of ends 53a and 53b of the coil conductor 53. The coil conductor 54 extends in the Z-axis direction. A longitudinal direction of the coil conductor 54 is orthogonal to the pair of side surfaces 3a. The entire coil conductor 54 overlaps the side surface electrode portion 5b when viewed along the Z-axis direction.

The coil conductor 55 extends from the coil conductor 61 toward the end surface 3e such that the shortest distance from the side surface 3a to the coil conductor 55 increases as the coil conductor 55 approaches the end surface 3e. In other words, the coil conductor 55 extends from the coil conductor 54 toward the end surface 3f such that the shortest distance from the side surface 3a to the coil conductor 55 decreases as the distance from the end surface 3e increases. A portion of the coil conductor 55 overlaps the side surface electrode portion 5b when viewed along the Z-axis direction. The coil conductor 55 is orthogonal to the X-axis direction and extends in a direction inclined with respect to the Y-axis direction and the Z-axis direction.

The coil conductor 61 includes a pair of ends 61a and 61b. The coil conductor 62 includes a pair of ends 62a and 62b. The coil conductor 63 includes a pair of ends 63a and 63b. The coil conductor 64 includes a pair of ends 64a and 64b. The coil conductor 65 includes a pair of ends 65a and 65b.

The end 61b of the coil conductor 61 and the end 62a of the coil conductor 62 are coupled to each other. The end 62b of the coil conductor 62 and the end 63a of the coil conductor 63 are coupled to each other. The end 63b of the coil conductor 63 and the end 64a of the coil conductor 64 are coupled to each other. The end 64b of the coil conductor 64 and the end 65a of the coil conductor 65 are coupled to each other.

The coil conductor 61 extends in the same direction as the coil conductor 55. When viewed along the X-axis direction, the coil conductor 61 and the coil conductor 55 are located on the same straight line. The end 55b of the coil conductor 55 and the end 61a of the coil conductor 61 are connected to each other via a via 91.

The coil conductor 62 extends along the Y-axis direction. When viewed along the Z-axis direction orthogonal to the direction of the coil axis CA of the coil CL and the Y-axis direction, the coil conductor 62 does not overlap the portion 5c which is closest to the coil conductor 62 in the side surface electrode portion 5b. When viewed along the Z-axis direction, the coil conductor 62 does not overlap the portion 6c which is closest to the coil conductor 62 in the side surface electrode portion 6b. The coil conductor 62 is separated from the portion 5c which is closest to the coil conductor 52 in the side surface electrode portion 5b in the Y-axis direction. The coil conductor 62 is separated from the portion 6c which is closest to the coil conductor 62 in the side surface electrode portion 6b in the Y-axis direction. The coil conductor 62 is connected to the end 61b of the coil conductor 61.

In the present modification, when viewed along the Z-axis direction, the coil conductor 62 does not overlap the side surface electrode portion 5b provided on the side surface 3a close to the coil conductor 62 in the pair of side surfaces 3a. When viewed along the Z-axis direction, the coil conductor 62 does not overlap the side surface electrode portion 6b provided on the side surface 3a close to the coil conductor 62 in the pair of side surfaces 3a. In the present modification, when viewed along the Z-axis direction, the coil conductor 62 does not overlap the side surface electrode portion 5b provided on each of the pair of side surfaces 3a. When viewed along the Z-axis direction, the coil conductor 62 does not overlap the side surface electrode portion 6b provided on each of the pair of side surfaces 3a. The coil conductor 62 is separated from the side surface electrode portions 5b and 6b provided on each of the pair of side surfaces 3a in the Y-axis direction.

The coil conductor 63 extends from the coil conductor 62 toward the end surface 3f such that the shortest distance from the side surface 3a to the coil conductor 63 increases as the coil conductor 63 approaches the end surface 3f. In other words, the coil conductor 63 extends from the coil conductor 64 toward the end surface 3e such that the shortest distance from the side surface 3a to the coil conductor 63 decreases as the distance from the end surface 3f increases. A portion of the coil conductor 63 overlaps the side surface electrode portion 6b when viewed along the Z-axis direction. The coil conductor 63 is orthogonal to the X-axis direction and extends in a direction inclined with respect to the Y-axis direction and the Z-axis direction.

The coil conductor 64 is connected to the end 63b of the coil conductor 63. The coil conductor 64 extends in the Z-axis direction. A longitudinal direction of the coil conductor 64 is orthogonal to the pair of side surfaces 3a. The entire coil conductor 64 overlaps the side surface electrode portion 6b when viewed along the Z-axis direction.

The coil conductor 65 extends from the coil conductor 21 toward the end surface 3f such that the shortest distance from the side surface 3a to the coil conductor 65 increases as the coil conductor 65 approaches the end surface 3f. In other words, the coil conductor 65 extends from the coil conductor 64 toward the end surface 3e such that the shortest distance from the side surface 3a to the coil conductor 65 decreases as the distance from the end surface 3f increases. A portion of the coil conductor 65 overlaps the side surface electrode portion 6b when viewed along the Z-axis direction. The coil conductor 65 is orthogonal to the X-axis direction and extends in a direction inclined with respect to the Y-axis direction and the Z-axis direction.

The coil conductor 71 includes a pair of ends 71a and 71b. The coil conductor 72 includes a pair of ends 72a and 72b. The coil conductor 73 includes a pair of ends 73a and 73b. The coil conductor 74 includes a pair of ends 74a and 74b. The coil conductor 75 includes a pair of ends 75a and 75b. The coil conductor 76 includes a pair of ends 76a and 76b.

The end 71b of the coil conductor 71 and the end 72a of the coil conductor 72 are coupled to each other. The end 72b of the coil conductor 72 and the end 73a of the coil conductor 73 are coupled to each other. The end 73b of the coil conductor 73 and the end 74a of the coil conductor 74 are coupled to each other. The end 74b of the coil conductor 74 and the end 75a of the coil conductor 75 are coupled to each other. The end 75b of the coil conductor 75 and the end 76a of the coil conductor 76 are coupled to each other.

The coil conductor 71 extends in the same direction as the coil conductor 65. When viewed along the X-axis direction, the coil conductor 71 and the coil conductor 65 are located on the same straight line. The end 65b of the coil conductor 65 and the end 71a of the coil conductor 71 are connected to each other via the via 81.

The coil conductor 72 has the same shape as the coil conductor 52 and has a configuration similar to that of the coil conductor 52. The coil conductor 72 is connected to the end 71b of the coil conductor 71. The coil conductor 73 has the same shape as the coil conductor 53 and has a configuration similar to that of the coil conductor 53. The coil conductor 73 is connected to the end 72b of the coil conductor 72. The coil conductor 74 has the same shape as the coil conductor 54 and has a configuration similar to that of the coil conductor 54. The coil conductor 74 is connected to the end 73b of the coil conductor 73.

The coil conductor 75 extends from the coil conductor 76 toward the end surface 3e such that the shortest distance from the side surface 3a to the coil conductor 75 increases as the coil conductor 75 approaches the end surface 3e. In other words, the coil conductor 75 extends from the coil conductor 74 toward the end surface 3f such that the shortest distance from the side surface 3a to the coil conductor 75 decreases as the distance from the end surface 3e increases. A portion of the coil conductor 75 overlaps the side surface electrode portion 5b when viewed along the Z-axis direction. The coil conductor 75 is orthogonal to the X-axis direction and extends in a direction inclined with respect to the Y-axis direction and the Z-axis direction.

The coil conductor 76 extends along the Y-axis direction. When viewed along the Z-axis direction, the coil conductor 76 does not overlap the portion 5c which is closest to the coil conductor 76 in the side surface electrode portion 5b. The coil conductor 76 is separated from the portion 5c which is closest to the coil conductor 76 in the side surface electrode portion 5b in the Y-axis direction. In the present modification, when viewed along the Z-axis direction, the coil conductor 76 does not overlap the side surface electrode portion 5b provided on the side surface 3a close to the coil conductor 76 in the pair of side surfaces 3a.

Next, effects of the coil components 1 and 1A in the present embodiment and the modification will be described.

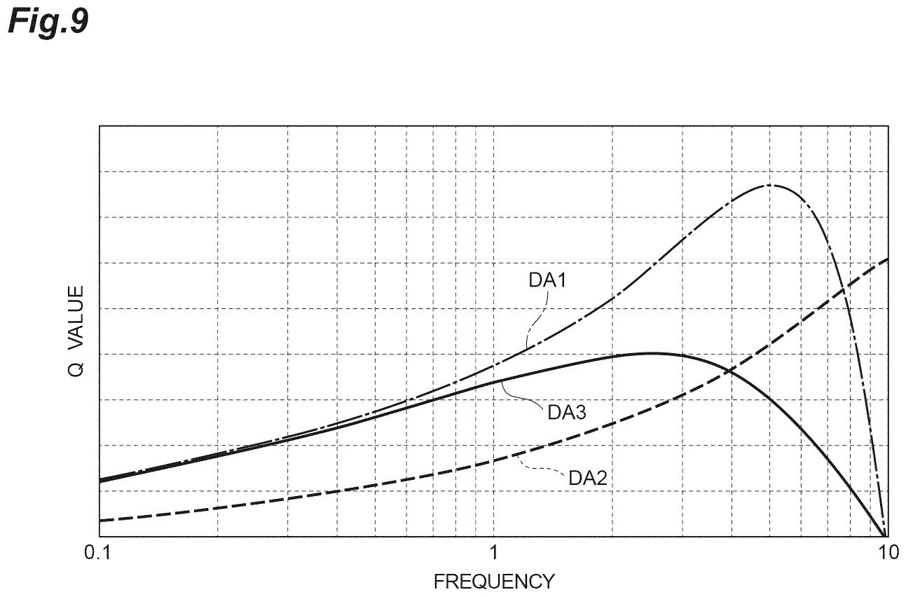

FIG. 9 is a graph illustrating frequency characteristics of a Q value. Data DA1 illustrates a frequency characteristic of the Q value in a normal coil component. Data DA2 illustrates a frequency characteristic of the Q value in a case where a coil is short-circuited to an external electrode in a portion other than an end. Data DA3 illustrates data in a configuration in which a desired Q value is secured when an electrical signal in a relatively low frequency band conducts through the coil, and the Q value decreases when an electrical signal in a relatively high frequency band conducts through the coil. When there is a position where a potential difference between the coil and the external electrode is relatively large and the distance is relatively short, the Q value decreases for the electric signal having a relatively low frequency as illustrated in the data DA3.

In the coil component 1, since the coil conductor 11 connected to the external electrode 5 is separated from the external electrode 6 when viewed along the Y-axis direction, the Q value can be secured even for a signal in a relatively high frequency band while compactness is achieved. Since the coil conductor 12 is connected to the coil conductor 11 and extends from the coil conductor 11 toward the end surface 3e such that the shortest distance from the side surface 3a to the coil conductor 12 increases as the coil conductor 12 approaches the end surface 3e, the area of the region R surrounded by the coil CL can be secured when viewed along the direction of the coil axis CA. As a result, it is possible to secure inductance while achieving compactness. The coil component 1A also has a similar configuration.

In the example illustrated in the present embodiment, the coil CL further includes the coil conductor 13 connected to the end 12b of the coil conductor 12. The coil conductor 13 extends along the Z-axis direction. In this case, when viewed along the direction of the coil axis CA, a larger area of the region R surrounded by the coil CL can be secured. As a result, it is possible to more reliably secure inductance while achieving compactness. The coil component 1A also has a similar configuration.

In the example illustrated in the present embodiment, a portion of the coil CL overlaps the side surface electrode portion 6b when viewed along the Z-axis direction. In this case, when viewed along the direction of the coil axis CA, a larger area of the region R surrounded by the coil CL can be secured. As a result, it is possible to more reliably secure inductance while achieving compactness. The coil component 1A also has a similar configuration.

In the example illustrated in the present embodiment, the region R surrounded by the plurality of coil conductors 11 has an octagonal shape when viewed along the direction of the coil axis CA. In this case, when viewed along the direction of the coil axis CA, a larger area of the region R surrounded by the coil CL can be secured. As a result, it is possible to more reliably secure inductance while achieving compactness.

Although the embodiment and modification of the present invention have been described above, the present invention is not necessarily limited to the above-described embodiment, and various modifications can be made without departing from the gist thereof.

For example, in the examples illustrated in the embodiment and the modification described above, a case where the region R has an octagonal shape when viewed along the X-axis direction has been described. However, the shape of the region R is not limited thereto. For example, when viewed along the X-axis direction, the region R may have a hexagonal shape or a polygonal shape having 10 or more sides. The region R may not have a strictly polygonal shape, and the coil conductor 10 constituting the side may not have a linear shape.

As understood from the description of the above-described embodiment, the present specification includes disclosure of the following aspects.

### (Appendix 1)

A coil component including:
an element body including first and second end surfaces opposite to each other in a first direction and a side surface connected to the first and second end surfaces;
a first external electrode including a first end surface electrode portion provided on the first end surface and a first side surface electrode portion provided on the side surface and extending from the first end surface toward the second end surface;
a second external electrode including a second end surface electrode portion provided on the second end surface and a second side surface electrode portion provided on the side surface and extending from the second end surface toward the first end surface; and
a coil disposed inside the element body, coupled to the first end surface electrode portion at the first end surface, and coupled to the second end surface electrode portion at the second end surface, in which
the coil includes a plurality of coil conductors each including a pair of ends,
each of the plurality of coil conductors is connected at the end to another coil conductor of the plurality of coil conductors,
the plurality of coil conductors include a first coil conductor extending along the first direction and a second coil conductor connected to the first coil conductor and extending from the first coil conductor toward the second end surface such that a shortest distance from the side surface to the second coil conductor increases as the second coil conductor approaches the second end surface, and
when viewed along a second direction orthogonal to a coil axis direction of the coil and the first direction, the first coil conductor does not overlap a portion which is closest to the first coil conductor in the second side surface electrode portion.

### (Appendix 2)

The coil component according to Appendix 1, in which the coil further includes a third coil conductor connected to an end different from an end connected to the first coil conductor, in the pair of ends of the second coil conductor, and
the third coil conductor extends in the second direction.

### (Appendix 3)

The coil component according to Appendix 1 or 2, in which a portion of the coil overlaps the second side surface electrode portion when viewed along the second direction.

### (Appendix 4)

The coil component according to any one of Appendixes 3 to 1, in which a region surrounded by the plurality of coil conductors has an octagonal shape when viewed along the coil axis direction.

### Reference Signs List

1 COIL COMPONENT
2 ELEMENT BODY
3a, 3c SIDE SURFACE
3e, 3f END SURFACE
5 5,6 EXTERNAL ELECTRODE
5a, 6a END SURFACE ELECTRODE PORTION
5b, 6b SIDE SURFACE ELECTRODE PORTION
10, 11, 12, 13 COIL CONDUCTOR
6c PORTION
10 CL COIL
CA COIL AXIS
R REGION

What is claimed is:

1. A coil component comprising:
an element body including first and second end surfaces opposite to each other in a first direction and a side surface connected to the first and second end surfaces;
a first external electrode including a first end surface electrode portion provided on the first end surface and a first side surface electrode portion provided on the side surface and extending from the first end surface toward the second end surface;
a second external electrode including a second end surface electrode portion provided on the second end surface and a second side surface electrode portion provided on the side surface and extending from the second end surface toward the first end surface; and
a coil disposed inside the element body, coupled to the first end surface electrode portion at the first end surface, and coupled to the second end surface electrode portion at the second end surface, wherein
the coil includes a plurality of coil conductors each including a pair of ends,
each of the plurality of coil conductors is connected at the end to another coil conductor of the plurality of coil conductors,
the plurality of coil conductors include a first coil conductor extending along the first direction and a second coil conductor connected to the first coil conductor and extending from the first coil conductor toward the second end surface such that a shortest distance from the side surface to the second coil conductor increases as the second coil conductor approaches the second end surface, and
when viewed along a second direction orthogonal to a direction of a coil axis of the coil and the first direction, the first coil conductor does not overlap a portion which is closest to the first coil conductor in the second side surface electrode portion.

2. The coil component according to claim 1, wherein the coil further includes a third coil conductor connected to an end different from an end connected to the first coil conductor, in the pair of ends of the second coil conductor, and
the third coil conductor extends in the second direction.

3. The coil component according to claim 1, wherein a portion of the coil overlaps the second side surface electrode portion when viewed along the second direction.

4. The coil component according to claim 1, wherein a region surrounded by the plurality of coil conductors has an octagonal shape when viewed along the direction of the coil axis.
